(19) United States
(12) Patent Application Publication
(10) Pub. No.: US 2014/0362129 A1
(43) Pub. Date: Dec. 11, 2014

(54) LIQUID CRYSTAL DISPLAY APPARATUS AND METHOD FOR DRIVING THE SAME

(71) Applicant: Japan Display Inc., Minato-ku (JP)

(72) Inventors: Yukio TANAKA, Tokyo (JP); Daiichi SUZUKI, Tokyo (JP); Kenji NAKAO, Tokyo (JP)

(73) Assignee: Japan Display Inc., Minato-ku (JP)

(21) Appl. No.: 14/291,614

(22) Filed: May 30, 2014

(30) Foreign Application Priority Data
Jun. 7, 2013 (JP) 2013-121008

(51) Int. Cl. G09G 3/36; G09G 3/34

(52) U.S. Cl. CPC G09G 3/3618; G09G 3/3406; G09G 2320/10
USPC 345/690; 345/102; 345/98

(57) ABSTRACT

According to one embodiment, a liquid crystal display apparatus includes a display panel on which a plurality of liquid crystal pixels are arrayed in a matrix, a lighting module arranged to be opposed to the display panel and configured to illuminate the display panel, and a control module configured to control image display on the display panel and luminance of a light source of the lighting module, the control module rewriting an image signal to the liquid crystal pixels by intermittent driving and controlling the luminance of the light source to be proportional to a reciprocal of transmittance of the display panel.

### CROSS-REFERENCE TO RELATED APPLICATIONS

This application is based upon and claims the benefit of priority from Japanese Patent Application No. 2013-121008, filed Jun. 7, 2013, the entire contents of which are incorporated herein by reference.

### FIELD

Embodiments described herein relate generally to a liquid crystal display apparatus and a method for driving the same.

### BACKGROUND

Liquid crystal display apparatuses are mounted on various devices, for example, television receivers, vehicle-installed displays such as car navigation equipment, notebook computers, tablet PCs, cellphones, mobile terminals such as smartphones, etc.

Liquid crystal of various modes is adopted in these liquid crystal display apparatuses in accordance with the application purposes.

For example, in a liquid crystal display apparatus of a vertical electric field system such as a twisted nematic (TN) mode or an optically compensated bend (OCB) mode, the alignment direction of the liquid crystal molecules included in a liquid crystal layer sandwiched between both the upper and lower substrates is controlled by an electric field produced between a counter electrode provided in the upper substrate and pixel electrodes provided in the lower substrate.

In addition, in a liquid crystal display apparatus of a lateral electric field system such as an in-plane switching (IPS) mode or a fringe-field switching (FFS) mode, a counter electrode (referred to as a COM electrode in this case) and pixel electrodes are provided on one substrate and an alignment direction of liquid crystal molecules included in a liquid crystal layer is controlled by an electric field (fringe electric field) generated between both the electrodes. The liquid crystal display apparatus of the FFS mode has high luminance and is excellent in view angle characteristics since a high aperture ratio can be secured.

It should be noted that in a liquid crystal display apparatus for a mobile terminal, reduction of circuit power consumption is strongly desired and low-frequency driving, intermittent driving or the like is proposed as power reduction means. Low-frequency driving is to reduce the circuit power by reducing the driving frequency of the liquid crystal display apparatus to ½, ¼, etc., relative to a standard condition. Intermittent driving is to reduce the circuit power by setting a circuit suspension period of several display periods after writing in one display period is executed. Neither means is suitable for moving image display since a video signal rewriting cycle at the liquid crystal display module becomes long. However, these means are effective for circuit power reduction at display of still images, etc., in which moving picture visibility is not considered so important.

However, when the low-frequency driving and the intermittent driving are carried out in the liquid crystal display apparatus, flicker needs to be reduced.

For example, when the frame frequency is 60 Hz, which is adopted in a general liquid crystal display apparatus, flicker is not apparent. When the frame frequency is 20 Hz, which is one-third of 60 Hz, flicker is apparent. When the frame frequency is further reduced, flicker is much more pronounced.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a schematic plan view showing a structure of a display apparatus of a present embodiment;

FIG. 2 is a cross-sectional view of a display pixel module of a liquid crystal display panel of the liquid crystal display apparatus of the present embodiment;

FIG. 3A is a graph showing an example of a luminance response waveform of the liquid crystal display apparatus in a case where backlight luminance is constant;

FIG. 3B is a graph showing an example of the luminance response waveform of the liquid crystal display apparatus in the case where the backlight luminance is constant;

FIG. 4A is a graph showing another example of the luminance response waveform of the liquid crystal display apparatus in the case where the backlight luminance is constant;

FIG. 4B is a graph showing another example of the luminance response waveform of the liquid crystal display apparatus in the case where the backlight luminance is constant;

FIG. 5 is a graph for illustrating backlight control of the liquid crystal display apparatus of the present embodiment;

FIG. 6 is another graph for illustrating the backlight control of the liquid crystal display apparatus of the present embodiment;

FIG. 7 is another graph for illustrating the backlight control of the liquid crystal display apparatus of the present embodiment;

FIG. 8 is a graph showing a relationship between an upper limit of luminance amplitude at which flicker is not apparent and a frame frequency, which is determined by subjective evaluation; and

FIG. 9 is a diagram showing a structure for implementing the backlight control of the liquid crystal display apparatus of the present embodiment.

### DETAILED DESCRIPTION

Various embodiments will be described hereinafter with reference to the accompanying drawings.

In general, according to one embodiment, a liquid crystal display apparatus includes a liquid crystal display apparatus comprising, a display panel on which a plurality of liquid crystal pixels are arrayed in a matrix, a lighting module arranged to be opposed to the display panel and configured to illuminate the display panel, and a control module configured to control image display on the display panel and luminance of a light source of the lighting module, the control module rewriting an image signal to the liquid crystal pixels by intermittent driving and controlling the luminance of the light source to be proportional to a reciprocal of transmittance of the display panel.

A liquid crystal display apparatus of an embodiment will be described hereinafter in detail with reference to the accompanying drawings.

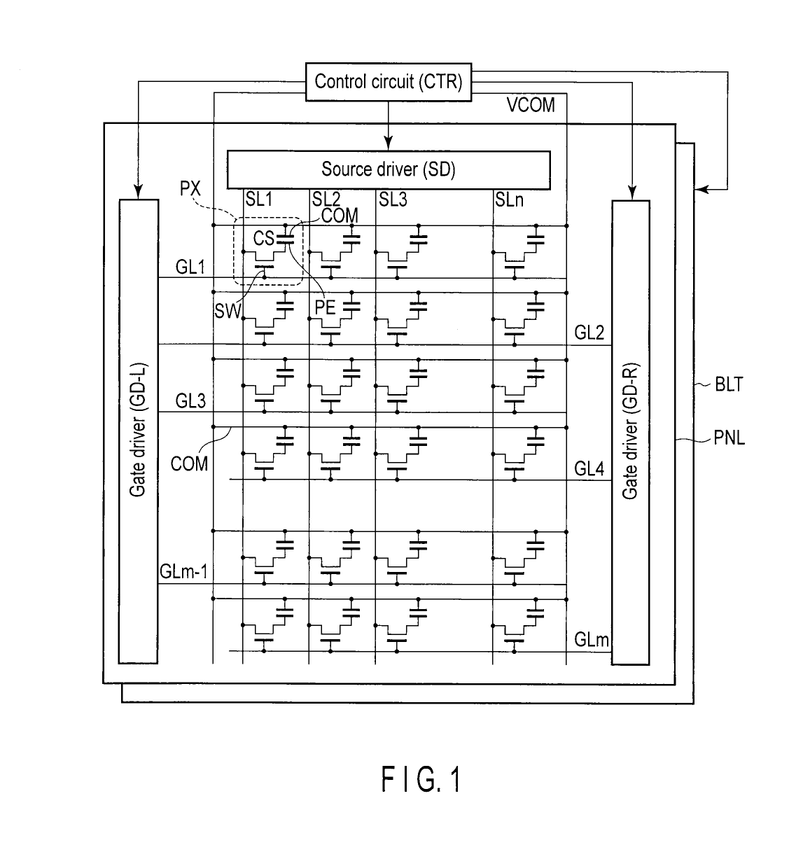

FIG. 1 is a schematic plan view showing a structure of the display apparatus of the present embodiment.

The liquid crystal display apparatus comprises a liquid crystal display panel PNL and a backlight BLT illuminating the liquid crystal display panel PNL from the back. A display module including display pixels PX arrayed in a matrix is provided on the liquid crystal display panel PNL.

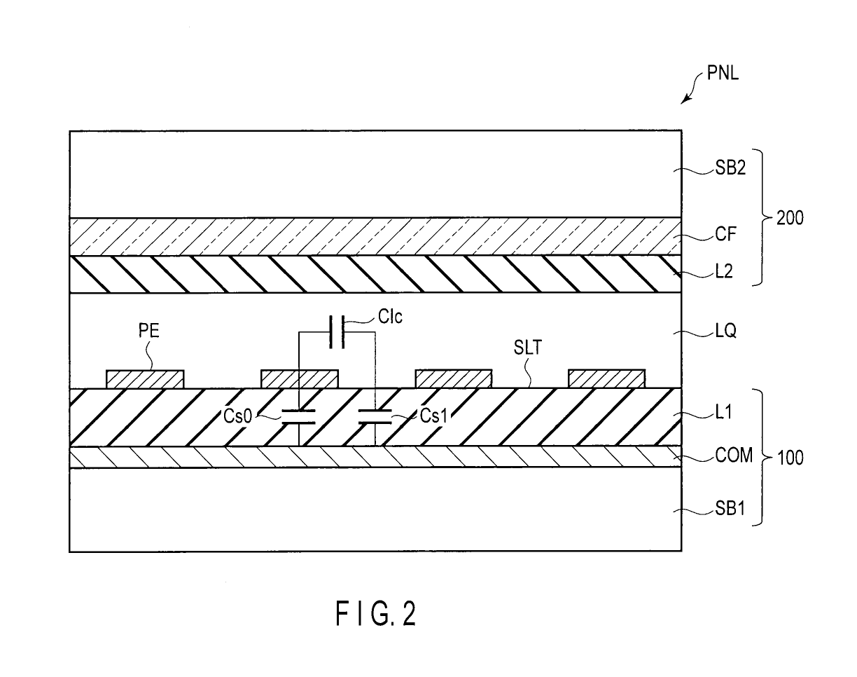

FIG. 2 is a cross-sectional view of a display pixel module of the liquid crystal display panel PNL of the liquid crystal display apparatus of the present embodiment.

The liquid crystal display panel PNL comprises an array substrate 100, a counter-substrate 200, and a liquid crystal layer LQ sandwiched between the paired substrates 100 and 200.

A transparent insulating substrate SB2, a color filter layer CF and an overcoat layer L2 are provided on the counter-substrate 200. The color filter layer CF includes colored layers of red (R), green (G) and blue (B) arranged on the transparent insulating substrate SB2. The overcoat layer L2 is provided so as to cover the color filter layer CF and prevents materials included in the color filter layer CF from flowing to the liquid crystal layer LQ.

The array substrate 100 comprises a transparent insulating substrate SB1, a counter-electrode (first electrode) COM, and a plurality of pixel electrodes (second electrodes) PE. The pixel electrodes PE are arranged on the counter-electrode COM via an insulating layer L1 such as silicon nitride (SiN). The pixel electrodes PE are arranged for the respective display pixels PX, and slit-like openings SLT are formed at the pixel electrodes PE. The counter-electrode COM and the pixel electrodes PE are transparent electrodes formed of, for example, indium tin oxide (ITO).

As shown in FIG. 1, in the display module, the array substrate 100 comprises scanning lines GL (GL1, GL2, . . . ), signal lines SL (SL1, SL2, . . . ), and pixel switches SW. The scanning lines GL extend along rows in which the display pixels PX are arranged. The signal lines SL extend along columns in which the display pixels PX are arranged. Each of the pixel switches SW is arranged to be adjacent to a position at which the scanning line GL and the signal line SL intersect with each other.

The pixel switch SW comprises a thin-film transistor (TFT). A gate electrode of the pixel switch SW is electrically connected to the corresponding scanning line GL. A source electrode of the pixel switch SW is electrically connected to the corresponding signal line SL. A drain electrode of the pixel switch SW is electrically connected to the corresponding pixel electrode PE.

The array substrate 100 comprises gate drivers GD

(GD-L on the left side and GD-R on the right side) and a source driver SD, as drivers for driving the plurality of display pixels PX. The plurality of scanning lines GL are electrically connected to output terminals of the gate drivers GD. The plurality of signal lines SL are electrically connected to output terminals of the source driver SD.

The gate drivers GD and the source driver SD are arranged in a region surrounding the display module. The gate drivers GD sequentially apply an on-voltage to the plurality of scanning lines GL and supply the on-voltage to the gate electrodes of the pixel switches SW electrically connected to the selected scanning lines GL. Source electrodes and drain electrodes of the pixel switches SW in which gate electrodes are supplied with the on-voltage become electrically conductive with each other. The source driver SD supplies output signals corresponding to the respective signal lines SL. The signals supplied to the signal lines SL are applied to the corresponding pixel electrodes PE via the signal switches SW in which the source electrodes and the drain electrodes become electrically conductive with each other.

Operations of the gate drivers GD and the source driver SD are controlled by a control circuit CTR arranged on the outside of the liquid crystal display panel PVL. The control circuit CTR supplies a counter voltage Vcom to the counter-electrode COM. Furthermore, the control circuit CTR controls operations of the backlight BLT.

Besides normal driving, the control circuit CTR has a function of intermittent driving in order to reduce driving power. A time interval when video signals of the pixels are rewritten is called “a frame period” or “one frame” and a reciprocal of the frame period is called “a frame frequency”. In the present embodiment, the same terms are used for low-frequency driving and intermittent driving.

As an example, it is assumed that a standard frame frequency of the liquid crystal display apparatus is 60 Hz (that is, the video signals are rewritten to the pixels every sixtieth of a second). For moving picture display, the operation is executed at a standard 60 Hz. At display of still images, etc., in which moving picture visibility is not considered so important, the control circuit CTR executes intermittent driving. After executing a writing operation (scanning from an upper part to a lower part of a screen) in 1/60 sec, the control circuit CTR sets a suspension period of, for example, 1/60, 3/60, 7/60 or 59/60 sec. If the writing operation of the control circuit CTR is stopped in the suspension period, the circuit power consumption during the suspension period is substantially zero. The circuit power consumption considered as a time average including the period of writing is reduced to ½, ¼, ⅛ or 1/60.

According to the above driving method, after the pixel voltage is written to each pixel PX, the pixel voltage needs to be maintained for a long time. Therefore, the TFT should preferably have a small off-leak current. For example, a TFT using IGZO (an oxide consisting of indium [In], gallium [Ga] and zinc [Zn]) generally has a small off-leak current and is considered to be a TFT suitable for the low-frequency driving.

The liquid crystal display apparatus of the present embodiment is a liquid crystal display apparatus of a fringe-field switching (FFS) mode which allows an electric field to be generated in the liquid crystal layer LQ by potential difference between voltages applied to the counter-electrode COM and the pixel electrodes PE and controls an alignment direction of liquid crystal molecules included in the liquid crystal layer. Transmitted light quantity of the light emitted from the backlight BLT is controlled by the alignment direction of the liquid crystal molecules.

As shown in FIG. 2, a capacitance component Cs0 occurs in a portion in which the pixel electrode PE and the counter-electrode COM are opposed to each other by sandwiching the insulating layer L1. In addition, an auxiliary capacitance component Cs1 and a liquid crystal capacitance Clc corresponding to an electric field sneaking around in the liquid crystal layer LQ are also present. If these capacities are comprehensively represented as a total capacitance Cs present between the pixel electrode PE and the counter-electrode COM, an equivalent circuit sandwiching the capacitance Cs between a drain of the TFT and the counter-electrode COM can be represented as shown in FIG. 1.

Next, a driving method for reducing flicker will be described.

If a DC voltage is applied to a liquid crystal material for a long time, a temporal change occurs in display characteristics by charge-up. Thus, frame driving which inverses positive and negative polarity per frame such that a DC average is approximately zero is generally executed. However, if positive and negative response characteristics (luminance-voltage characteristics) are different, positive and negative frames have different luminance, brightness and darkness are varied in each frame and flicker thereby occurs. Flicker can be minimized by applying a minute offset voltage to a positive and negative average (DC average value) of signals or adjusting a counter-electrode potential, but it is difficult to completely absorb a temporal shift of luminance-voltage characteristics, a difference between gradations in optimum conditions, etc., and perfectly eliminate flicker.

As means for reducing such flicker, for example, inversion driving such as line inversion, column inversion and dot inversion is known. For example, the line inversion can cause flicker not to be apparent by inverting and distributing phases of temporal positive and negative polarity inversion per row and macroscopically canceling difference in brightness response between positive and negative. The column inversion and the dot inversion can similarly cause flicker not to be apparent by inverting phases of temporal positive and negative polarity inversion, per column in the former, and in a checkerboard pattern in the latter.

Of these inverse methods, the line inversion and the dot inversion execute writing to the pixels while executing polarity inversion per line at screen scanning. Therefore, charging and discharging of the signal lines in the panel need to be executed per H period (horizontal period) and the circuit power consumption is increased. In contrast, the column inversion is advantageous in view of reduction of the circuit power consumption since polarity inversion in rows is not executed in the column inversion. Various inversion methods are adopted depending on product specifications in a mobile liquid crystal display apparatus, and a column inversion method is the most desirable in view of power reduction.

Next, a luminance response waveform of the liquid crystal display apparatus will be described.

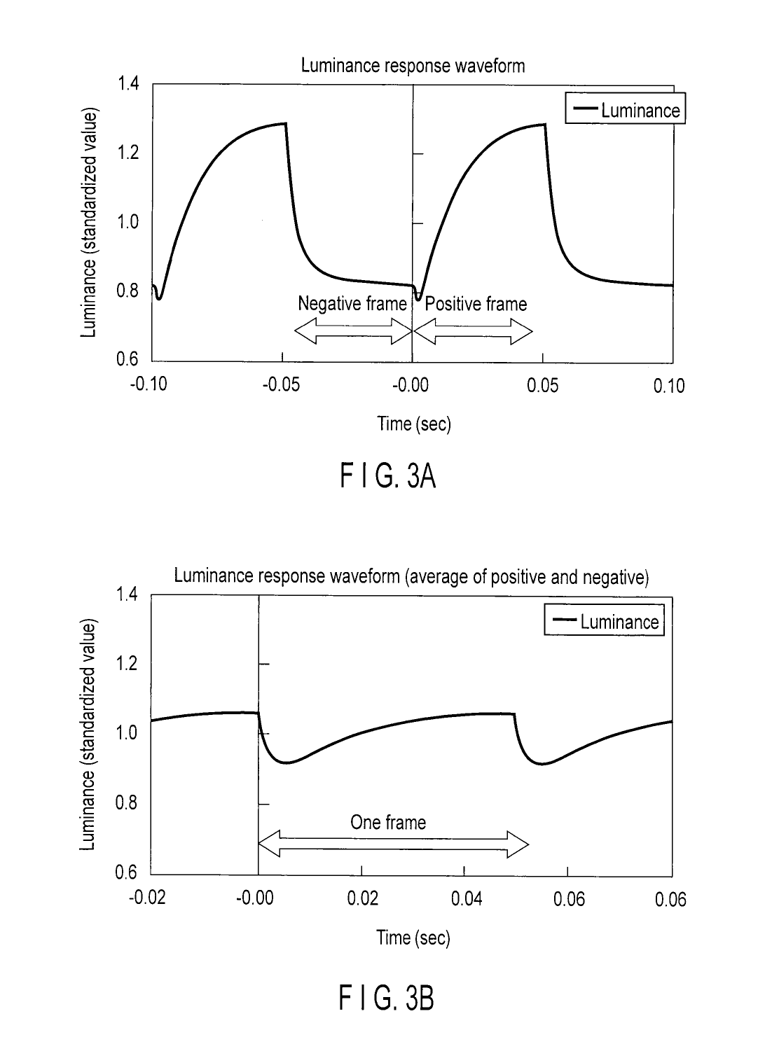

FIG. 3A and FIG. 3B are graphs showing an example of the luminance response waveform of the liquid crystal display apparatus in a case where backlight luminance is constant.

FIG. 3A shows a luminance response of a pixel at the driving in a frame period of 50 msec (frame frequency of 20 Hz). In the figure, a vertical axis represents luminance and a horizontal axis represents time. The luminance is standardized such that an average value is 1. The polarity of the video signals written to the pixels is inversed per frame. Intervals represented by arrows correspond to a negative frame and a positive frame, respectively.

In the luminance response shown in FIG. 3A, the luminance value is increased to approximately 1.3 in the positive frame and decreased to approximately 0.8 in the negative frame, and the luminance is considerably different in the positive and negative frames. This is because voltages maintained in liquid crystal are not exactly the same in the positive and negative frames under the influence of parasitic capacitive coupling, etc., or the liquid crystal itself has an internal field caused by the charge-up and a DC operating point is shifted.

As another feature, it is confirmed that the luminance is decreased for several milliseconds immediately after the negative frame is switched to the positive frame. This is a phenomenon unique to the FFS mode and is thought to occur because the liquid crystal molecules have spontaneous polarization due to a flexo-electric effect of the liquid crystal and the alignment direction of the liquid crystal molecules is changed by immediately responding to inversion of the electric field.

FIG. 3B shows a waveform obtained by averaging the luminance response of each of the positive and negative frames in FIG. 3A (in other words, adding two waveforms and dividing the waveforms by two). The waveform shown in FIG. 3B corresponds to a luminance response waveform observed macroscopically when the liquid crystal display apparatus is driven by the line inversion, the column inversion, the dot inversion, etc. (when focusing attention on a sufficiently wide region including both positive and negative pixels in almost equal numbers). The influence of the luminance difference between the positive and negative frames is cancelled by positive and negative averaging. However, a phenomenon where the luminance is decreased for a moment immediately after the polarity inversion (leading part of the frame) occurs and, accordingly, the luminance variation of brightness and darkness in the period of 50 msec is left. The luminance reduction at the leading part of the frame is caused by the flexo-electric effect, and considered to be the luminance variation left without being cancelled by positive and negative averaging.

It should be noted that flicker visible sensitivity of human vision is generally known to be frequency dependent. If the luminance variation of the amplitude is the same, flicker becomes more apparent as a frequency becomes lower.

FIG. 8 is a graph showing a relationship between an upper limit of luminance amplitude at which flicker is not apparent and a frame frequency. The relationship is determined by subjective evaluation. The graph rises sharply at a point where the frame frequency exceeds 40 Hz, indicating that flicker is not apparent at a frame frequency greater than 40 Hz even if the luminance amplitude is great, and that flicker is apparent at a frame frequency of 40 Hz or lower even if the luminance amplitude is low.

According to the result of the subjective evaluation, it is considered that flicker is not apparent at a general frame frequency of 60 Hz, but becomes apparent when a frame frequency is lowered to 40 Hz, in a case where the luminance variation of the amplitude shown in FIG. 3B occurs.

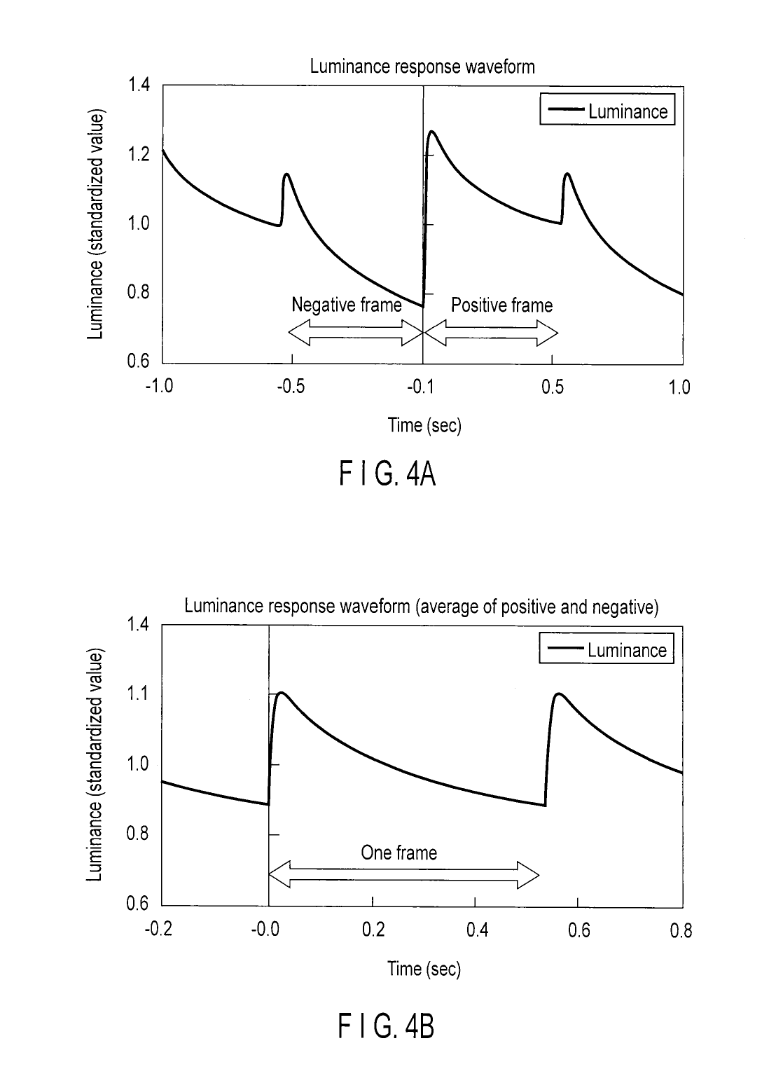

FIG. 4A and FIG. 4B are graphs showing another example of the luminance response waveform of the liquid crystal display apparatus obtained when the backlight luminance is constant.

FIG. 4A is a luminance response for one pixel at the driving at a further lower frame frequency of 1.85 Hz (frame period of 540 msec). FIG. 4A is the same as FIG. 3A in that the luminance is considerably different in the positive and negative frames. However, FIG. 4A is different from FIG. 3A in that the luminance is reduced with time (in other words, has declination from top left to bottom right) within the frame period whether in the positive frame or the negative frame. The luminance variation is considered to occur since a liquid crystal holding voltage decays with time because of resistivity of the liquid crystal not being sufficiently high, or voltage distribution temporally varies because of difference in resistivity between the liquid crystal and an alignment film or an insulating layer.

A phenomenon where the luminance increases rapidly occurs immediately after the polarity inversion whether in the positive frame or the negative frame. This indicates that the luminance is reset by writing of a normal voltage in a state where the luminance is decreased within the frame period as described above, and is a secondary phenomenon due to the decrease of the luminance within the frame period.

Next, FIG. 4B shows a waveform obtained by averaging the luminance response of each of the positive and negative frames in FIG. 4A (in other words, adding two waveforms and dividing the waveforms by two). In the waveform shown in FIG. 4B, the influence of the luminance difference between the positive and negative frames is canceled by positive and negative averaging. However, the influence of the luminance reduction within the frame period is left without being canceled and, accordingly, the luminance variation of brightness and darkness in the period of 540 msec is left. A frequency of the luminance variation is 1.85 Hz, which is lower than the frequency of the luminance variation shown in FIG. 3B. Therefore, flicker is much more pronounced because of the feature shown in FIG. 8.

The liquid crystal display apparatus of the present embodiment reduces the above-described flicker by controlling the backlight BLT.

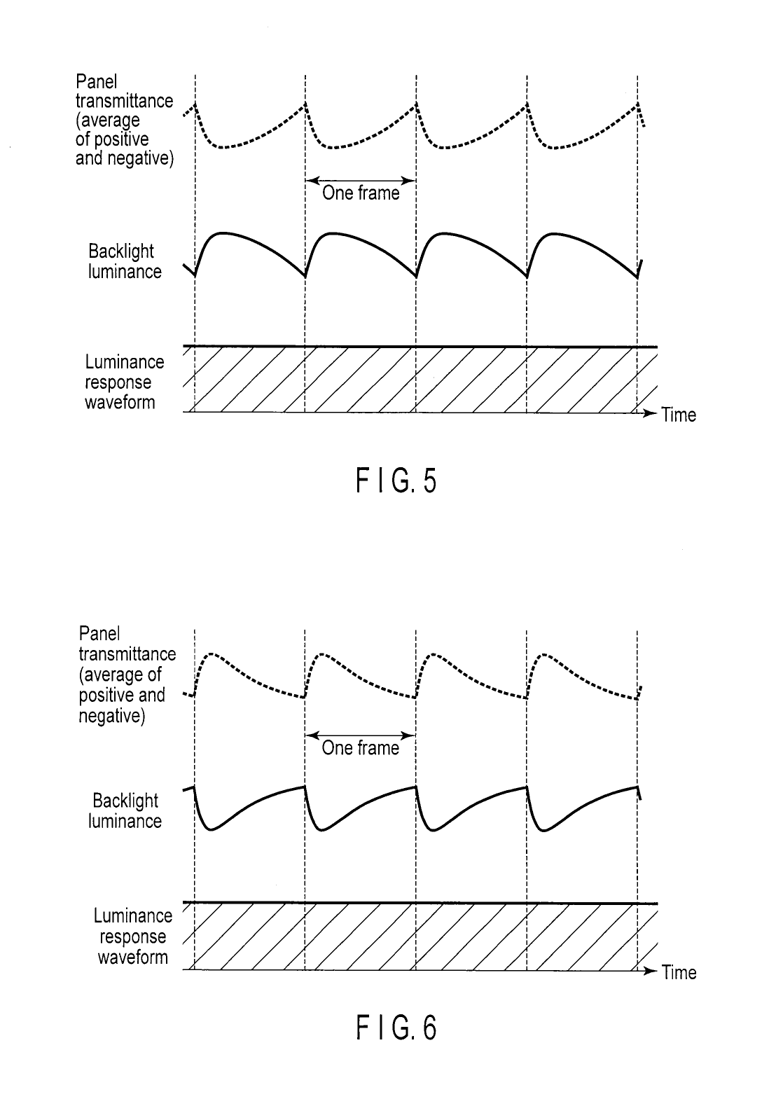

FIG. 5 is a graph for illustrating the backlight control of the liquid crystal display apparatus of the present embodiment.

FIG. 3B indicates that the temporal luminance variation macroscopically occurs under the condition of constant backlight luminance. This means that transmittance of the liquid crystal display panel PNL is varied in accordance with this luminance waveform. FIG. 5 represents variation of the transmittance of the liquid crystal display panel PNL by a broken line.

Thus, the luminance of the backlight BLT is varied in proportion to the reciprocal of the transmittance of the liquid crystal display panel PNL. Since luminance of light which is output from the backlight, passes through the panel and is observed is represented as a product of the backlight luminance and the panel transmittance, the luminance is temporally constant as shown in a luminance response waveform at the bottom of FIG. 5, and flicker is not apparent.

FIG. 6 is another graph for illustrating the backlight control of the liquid crystal display apparatus of the present embodiment.

FIG. 6 is an example in a case where the macroscopic variation of the transmittance of the liquid crystal display panel PNL shown in FIG. 4B occurs. Similarly to FIG. 5, the temporally constant luminance response waveform can be obtained by varying the luminance of the backlight BLT in proportion to the reciprocal of the transmittance of the liquid crystal display panel PNL, and flicker is not apparent.

FIG. 5 and FIG. 6 show the control method in a case where the luminance response of the positive and negative frames is cancelled, in other words, in a case of driving by column inversion, line inversion, dot inversion or the like. However, this method can also be applied to a case where a whole screen has the same polarity and cancellation of the luminance response does not occur, such as a case of driving by frame inversion.

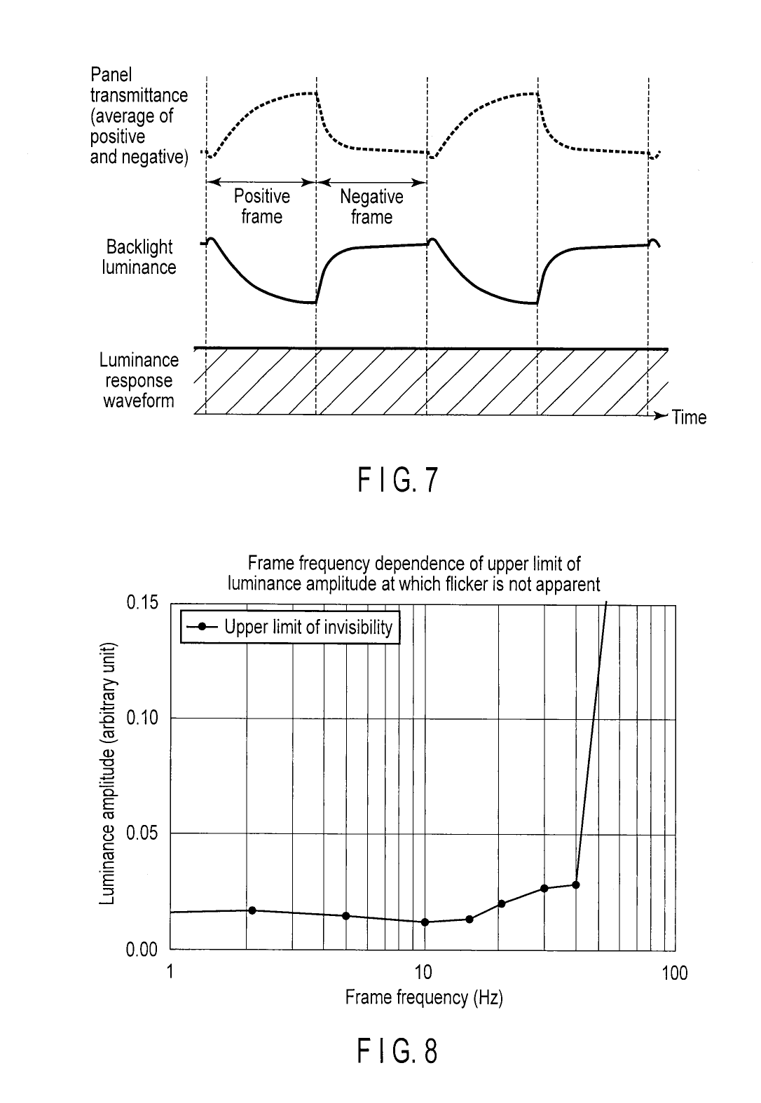

FIG. 7 is another graph for illustrating the backlight control of the liquid crystal display apparatus of the present embodiment.

In a case of driving by the frame inversion, the panel transmittance is represented by, for example, a waveform shown in FIG. 3A. Even in such a case, the temporally constant luminance response waveform can be obtained by varying the backlight luminance in proportion to the reciprocal of the panel transmittance, and flicker is not apparent.

The several embodiments are described above, but strictly speaking, it is considered that the panel transmittance waveform depends on display gradation and that the most suitable backlight control waveform is varied according to the display gradation. However, if the control of the backlight luminance is executed by a waveform proportional to the reciprocal of the panel transmittance in gradation where flicker is most apparent, for example, 127/255 gradation in 8-bit gradation display, a certain degree of flicker suppressing effect can be achieved in other gradations. Therefore, the embodiments can be sufficiently applied to practical use.

Furthermore, the embodiments are applicable to varying the backlight luminance waveform in accordance with the average gradation of an image displayed on the panel. The embodiments are also applicable to dividing the panel into a plurality of regions and selecting a backlight luminance control waveform suitable for each region in response to the average gradation of each region.

If an LED backlight is used as the backlight in each of the above-described embodiments, the luminance waveform can be controlled by current control. Alternatively, of course, the luminance control can be executed by pulse-width modulation (PWM).

The control circuit CTR has functions to control both the liquid crystal display panel PNL and the backlight BLT. If these functions are separated, it is possible to stop the former and operate the latter during the suspension period at the intermittent driving, and the power consumption of the circuit can be effectively reduced, and the circuit power consumption can be effectively reduced.

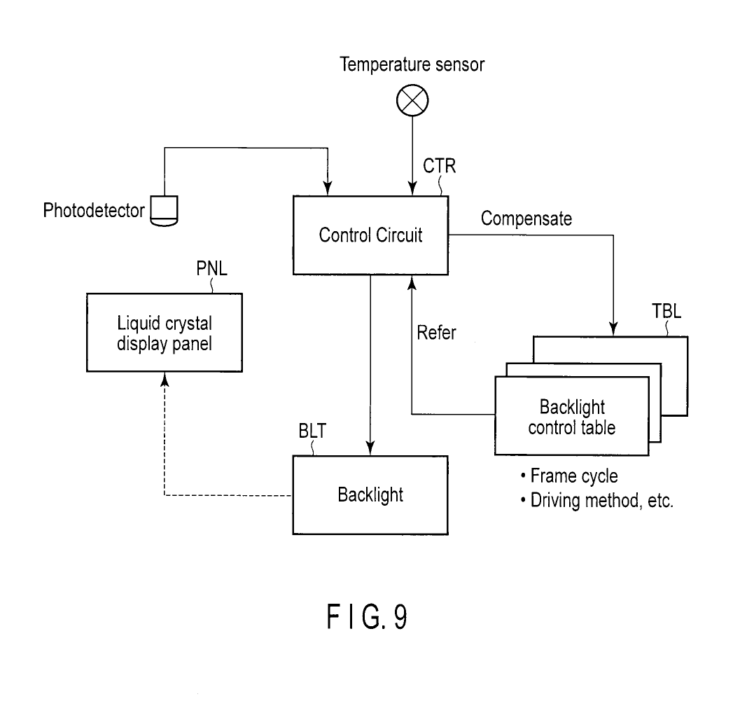

FIG. 9 is a diagram showing a structure for implementing the backlight control of the liquid crystal display apparatus of the present embodiment.

A backlight control table TBL is provided in the liquid crystal display apparatus of the present embodiment. The backlight control table TBL stores a plurality of backlight luminance data elements corresponding to frame frequency, driving method (normal driving, low-frequency driving, intermittent driving, etc.) and inversion method (frame inversion, line inversion, column inversion, dot inversion, etc.).

The control circuit CTR refers to the backlight control table TBL and controls the luminance of the backlight BLT in accordance with the stored backlight luminance data.

The liquid crystal display apparatus of the present embodiment may be equipped with a temperature sensor configured to measure temperature of the vicinity of the backlight BLT. The control circuit CTR compensates for the backlight luminance data based on the temperature and controls the luminance of the backlight BLT.

Furthermore, the liquid crystal display apparatus of the present embodiment may be equipped with at least one photodetector configured to measure the luminance of the liquid crystal display panel PNL. The control circuit CTR compensates for the backlight luminance data based on the measured luminance so as to obtain desirable luminance and controls the luminance of the backlight BLT.

As shown in FIG. 8, flicker is apparent when the frame frequency is 40 Hz or lower. Therefore, it is considered that the backlight control of the present embodiment can achieve a particularly conspicuous flicker reduction effect at the frame frequency of 40 Hz or lower.

The liquid crystal of the FFS mode is described in the above embodiment. However, the embodiment is not limited to this. The embodiment can also be applied to liquid crystal of an IPS mode, liquid crystal of a lateral electric field system, liquid crystal of a vertical electric field system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display apparatus comprising:
a display panel on which a plurality of liquid crystal pixels are arrayed in a matrix;
a lighting module arranged to be opposed to the display panel and configured to illuminate the display panel; and
a control module configured to control image display on the display panel and luminance of a light source of the lighting module,
the control module rewriting an image signal to the liquid crystal pixels by intermittent driving and controlling the luminance of the light source to be proportional to a reciprocal of transmittance of the display panel.

2. The apparatus of claim 1, wherein the control module further rewrites the image signal to the liquid crystal pixels by inversion driving.

3. The apparatus of claim 2, wherein a frame frequency of the inversion driving is 40 Hz or lower.

4. The apparatus of claim 3, further comprising liquid crystal of a lateral electric field system.

5. The apparatus of claim 1, wherein a frame frequency of the inversion driving is 40 Hz or lower.

6. The apparatus of claim 5, further comprising liquid crystal of a lateral electric field system.

7. A method of driving a liquid crystal display apparatus comprising a display panel on which a plurality of liquid crystal pixels are arrayed in a matrix and a lighting module arranged to be opposed to the display panel and configured to illuminate the display panel, the method comprising:
rewriting an image signal to the liquid crystal pixels by intermittent driving; and
controlling luminance of a light source of the lighting module to be proportional to a reciprocal of transmittance of the display panel.

8. The method of claim 7, further comprising rewriting the image signal to the liquid crystal pixels by inversion driving.
